(19) United States
(12) Patent Application Publication
(10) Pub. No.: US 2003/0225709 A1
(43) Pub. Date: Dec. 4, 2003

(54) Communication method, computer, and program

(76) Inventor: Masakazu Ukita, Kanagawa (JP)

Correspondence Address: WILLIAM S. FROMMER, Esq,, c/o FROMMER LAWRENCE & HAUG LLP, 745 Fifth Avenue, New York, NY, 10151, US

(21) Appl. No.: 10/390,210

(22) Filed: Mar. 17, 2003

(30) Foreign Application Priority Data
Mar. 19, 2002 (JP) P2002-076773

(51) Int. Cl. G06F 17/60

(52) U.S. Cl. 705/78

(57) ABSTRACT

A communication method, computer, and program enabling suitable payment of a charge to a content data provider even in a case where content data is provided by a peer-to-peer system on a network, wherein a third computer registers personal management data of a content provider and a content user and content management data concerning the content data transmitted by a first computer and the third computer performs processing for payment of the charge from the content user to the content provider based on the personal management data and the content management data in response to a request for payment of charge received from a second computer.

### BACKGROUND OF THE INVENTION

1. Field of the Invention

The present invention relates to a communication method, computer, and program used when providing content data on the Internet or another network, more particularly relates to a communication method, computer, and program for assisting payment of a charge by a user of the content to a provider.

2. Description of the Related Art

The general demand for widely distributing music, still images, moving pictures, computer programs, novels, poems, and other content on the Internet is increasing more and more. At this time, while desiring use of the content of one's own work by more people, there is a demand that some sort of profit be obtained from such work.

In a peer-to-peer file exchange service on a network, a file is placed in the computer of a service user connected to the network and that file is exchanged via the network. That is, the person who provides the file on the network does not have to place the file in a specific server on the network, therefore there is the advantage that it is not necessary to prepare a storage device for storing a large amount of files or an expensive network apparatus for processing network access concentrating at the server. For this reason, there is a possibility that the peer-to-peer file exchange service can satisfy the above general demand.

However, the digitalized data on the Internet, including the data of the files exchanged by the conventional peer-to-peer file exchange service, can be easily copied by anyone. Therefore, the provider of the content cannot obtain profit so far as the file exchange and copying are carried out at a place where the provider is not involved.

Simultaneously, there are cases where a true provider of content included in a file becomes unable to be determined.

Therefore, the content provider who wants to secure profit by preventing copying has to prepare some special mechanism for preventing unrestricted copying and provide the content to the Internet on that mechanism. In many cases, however, there is a problem in that the special mechanism becomes an obstacle for providing the content to many users.

On the other hand, due to the peer-to-peer file exchange service etc., even if satisfied with the content and wanting to pay a charge or make a contribution to the content provider, the content user using content provided on the Internet cannot easily pay the charge and is forced to give up since there is no means for easily specifying the true provider of the content.

Further, the user of the content could not easily determine in advance if a file obtained from the Internet by for example peer-to-peer file exchange etc. included a computer virus, socially unsuitable content, content not desired by oneself, or the like before actually using the content. For this reason, he or she could not feel safe about using the content.

### SUMMARY OF THE INVENTION

An object of the present invention is to provide a communication method, a computer, and a program enabling one to suitably pay a charge to a content data provider even when the content data is provided on the network by the peer-to-peer system.

To attain the above object, according to a first aspect of the present invention, there is provided a communication method of a third computer for communicating with a first computer of a content provider and a second computer of a content user when the first computer transmits content data to the second computer, comprising the steps of communicating by the third computer with the first computer and the second computer to register personal management data concerning the content provider and the content user, and content management data concerning the content data, receiving by the third computer from the second computer, a request for payment of a charge to the content provider for reception of the content data, and performing by the third computer a task for payment of the charge to the content provider, based on the registered personal management data and the content management data in response to the request for payment.

The mode of operation of the communication method of the first aspect of the invention becomes as follows.

First, the third computer communicates with the first computer and the second computer to register the personal management data concerning the content provider and the content user, and the content management data concerning the content data.

Then, the content data is transmitted from the first computer to the second computer.

Then, the content user operates the second computer when he or she wants to pay the charge to the content provider and transmits the request for payment of the charge from the content user to the content provider for the reception of the content data to the third computer.

Then, the third computer performs a task for payment of the charge to the content provider, based on the personal management data and the content management data in response to the request for payment.

In this way, in the communication method of the first aspect of the invention, even in a case where the content data is transmitted by the peer-to-peer system between the first computer and the second computer, payment of a charge from the content user to the content provider is enabled.

The communication method of the first aspect of the invention preferably further manages by the third computer the total amount of the charge paid with respect to each content data by using the content management data.

Alternatively, the communication method of the first aspect of the invention preferably further registers by the third computer further verification data indicating the legitimacy of the content data provided by the content provider, receives by the third computer a request inquiring about the legitimacy of the content data from the second computer, and verifies by the third computer the legitimacy of the content data by using the verification data in response to the inquiry request and transmit the result of the related verification to the second computer.

Alternatively, the communication method of the first aspect of the invention preferably further registers by the third computer hash key data of the content data generated based on a predetermined hash function as the verification data, receives by the third computer the inquiry request including the hash key data of the content data from the second computer, and compares by the third computer the registered hash key data with the hash key data included in the inquiry request and verify the legitimacy of the content data.

Alternatively, the communication method of the first invention preferably receives by the third computer the content data from the first computer and generates and registers by the third computer the hash key data of the received content data based on the hash function.

Alternatively, the communication method of the first invention preferably receives by the third computer the hash key data of the content data generated by the first computer based on the hash function from the first computer and register the same.

According to a second aspect of the invention, there is provided a computer for communicating with a first computer used by a content provider and a second computer, used by a content user, to receive content data from the first computer, comprising a storage means for storing personal management data for managing the content provider and the content user, and content management data for managing the content data; an interface for receiving from the second computer a request for payment of a charge to the content provider for reception of the content data; and a controlling means for performing a task for payment of the charge to the content provider, based on the personal management data and the content management data in response to the request for payment.

The mode of operation of the computer of the second aspect of the invention becomes as follows.

The personal management data for managing the content provider and the content user and the content management data for managing the content data are stored in advance in the storage means by registration processing.

Then, the interface receives a request for payment of the charge from the content user to the content provider for the reception of the content data from the second computer.

Then, the controlling means performs processing for paying the charge from the content user to the content provider based on the personal management data and the content management data in response to the request for payment.

According to a third aspect of the invention, there is provided a program to be executed in a computer for communicating with a first computer used by a content provider and a second computer, used by a content user, to receive content data from the first computer, comprising a routine for registering personal management data for managing the content provider and the content user, and content management data for managing the content data; a routine for receiving from the second computer a request for payment of a charge to the content provider for the reception of the content data; and a routine for performing a task for payment of a charge to the content provider, based on the personal management data and the content management data in response to the request for payment.

The program of the third aspect of the invention is executed at a computer and makes the computer perform for example functions similar to those of the communication method of the first aspect of the invention.

### BRIEF DESCRIPTION OF THE DRAWINGS

These and other objects and features of the present invention will become clearer from the following description of the preferred embodiments given with reference to the attached drawings, wherein:

FIG. 1 is a view of the overall configuration of a communication system of an embodiment of the present invention;

FIG. 2 is a functional block diagram of a computer shown in FIG. 1;

FIG. 3 is a view for explaining user personal data stored in a user database shown in FIG. 2;

FIG. 4 is a view for explaining content management data stored in a content database shown in FIG. 2;

FIG. 5 is a view for explaining transaction management data stored in a transaction database shown in FIG. 2;

FIG. 6 is a flowchart for explaining an example of operation of a case where a content provider registers himself or herself in a computer;

FIG. 7 is a flowchart for explaining an example of operation of a communication system where a content user registers himself or herself in a computer;

FIG. 8 is a flowchart for explaining an example of operation of a communication system where a content provider registers content data in a computer;

FIG. 9 is a flowchart for explaining an example of an operation of a case where one computer downloads a file data from another computer by a peer-to-peer system and inquires about legitimacy of the related file data to still another computer; and

FIG. 10 is a flowchart for explaining an example of operation of a case where a content user receiving a download of file data from the content provider pays a charge to the content provider.

### DESCRIPTION OF THE PREFERRED EMBODIMENTS

First, an explanation will be given of a communication system according to an embodiment of the present invention.

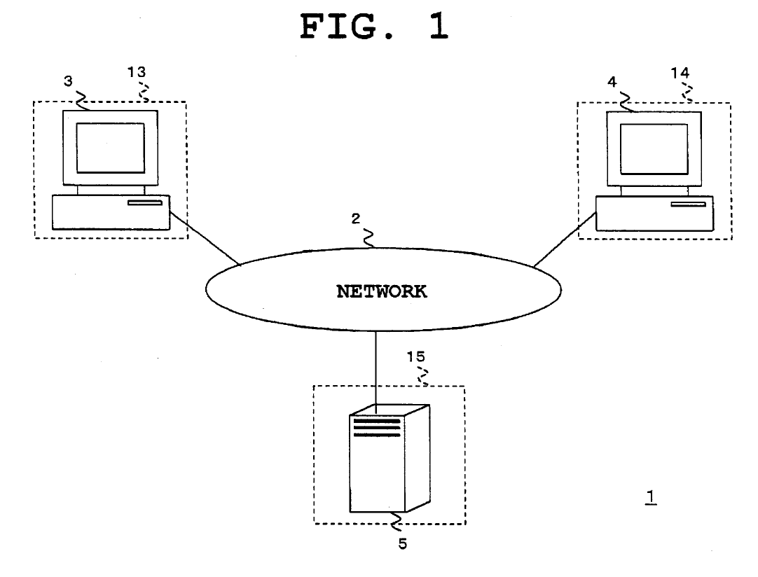

FIG. 1 is a view of the overall configuration of a communication system 1 of the present embodiment.

As shown in FIG. 1, the communication system 1 has, for example, a computer 3 used by a content provider 13, a computer 4 used by a content user 14, and a computer 5 used by a mediator 15. These are connected via a network 2 such as the Internet.

Here, the computer 3 corresponds to the first computer of the present invention, while the computer 4 corresponds to the second computer of the present invention.

Further, the computer 5 corresponds to the third computer of the first invention and corresponds to the computer of the second and third aspects of the inventions.

Further, the content provider 13 corresponds to the content provider of the present invention, while the content user 14 corresponds to the content user of the present invention.

First, an explanation will be given of an outline of the processing of the communication system 1 shown in FIG. 1.

In the communication system 1, the content provider 13 operates the computer 3 to freely transmit file data storing content data via the network 2 to other users (content users) by the peer-to-peer system.

In the communication system 1, further, the content provider 13 operates the computer 3 to register his or her personal information and hash key data determined from the file data storing the content data to be provided via the network 2 in the computer 5.

Next, the content provider 13 operates the computer 3 to open to the public the registered file data on the network 2.

The content user 14 operates the computer 4 to search for the file data opened to the public on the computer 3 by a search service provided by the mediator 15 by using the computer 5 or by another means.

Then, the content user 14 operates the computer 4 to download and use the file data opened to the public on the computer 3 into the computer 4 via the network 2 by the peer-to-peer system.

The content user 14 operates the computer 4 in order to inquire about the legitimacy of the related downloaded file data (for example, the legitimacy of the preparation side of the related file data or if a computer virus or socially unsuitable content is included in the related file data) to the computer 5, generates the hash key data of the downloaded file data, and transmits an inquiry request including the related hash key data to the computer 5.

The computer 5 compares the hash key data included in the related inquiry request and the registered hash key data for the related content data in response to the inquiry request, verifies the legitimacy of the related content data, and transmits the result of the verification to the computer 4.

At this time, the computer 5 may provide, other than the result of the verification, information concerning the provider, content information, that is a summary of the content, a field to which the content belongs (for example, text, music, still images, video, programs), the rough category (for example, in the case of text, a novel, poem, or essay; in the case of music, rock, folk, or jazz; in the case of a still image, a photograph or painting; in the case of video, a real picture or animation; and in the case of a program, the application of the program), and information such as a further smaller classification to the computer 4. It is assumed that the above information is registered in the computer 5 in advance.

Further, when the content user 14 wish to pay a charge (make a contribution) to the related provider for the reception of the provision of the related content data, he or she operates the computer 4 to transmit a request for payment of the charge including the user ID of the related user, the hash key data of the related content data, charge amount data indicating the amount of the charge, etc. to the computer 5.

The computer 5 searches for the provider of the content from the already registered information based on the hash key data included in the related request for payment of charge, and mediates the charge payment. Namely, the mediator 15 mediates the transfer of money between the user and the provider while interposed therebetween.

In the present embodiment, the computer 5 of the mediator 15 has the role of smoothly mediating the payment of the charge (contribution) from the content user 14 to the content provider 13.

Further, the computer 5 can provide information concerning the content data provided by the content provider 13, including if it is registered, to the content user 14, can provide a table of the registered content data to the content user 14 in an easily useable format, and can provide information indicating how much of a charge is to be paid with respect to which content data to the content provider 13 and the content user 14.

Further, the computer 5 performs processing for introducing content data matching the preferences of the related content user 14 to the content user 14 based on the type, genre, etc. of the content data which the content user 14 paid charges for in the past.

Further, the mediator 15 may also make the computer 5 perform processing for charging the content provider 13 or the content user 14 for the above service by the computer 5.

Further, the mediator 15 may also make the computer 5 perform a processing for collecting an advertisement insertion fee from an advertiser by inserting some sort of advertisement together with the service when providing the same.

Next, an explanation will be given of the components shown in FIG. 1.

[Computer 3]

The computer 3 is used by the content provider 13 as mentioned above.

The computer 3 is connected to the network 2 and transmits personal data USER_INF concerning the content provider 13 to the computer 5 for it to register.

Further, the computer 3 opens to the public file data storing the content data on the network 2 by the peer-to-peer system for the content data relating to the content provider 13.

Further, the computer 3 generates hash key data from the file data of the content data to be provided by using the predetermined hash function and transmits the related hash key data and the related file data to the computer 5.

[Computer 4]

The computer 4 is used by the content user 14 as mentioned above.

The computer 4 is connected to the network 2, and downloads the file data of the content data from the computer 3 by the peer-to-peer system via the network 2.

Further, when the content user 14 wishes to pay a charge for the downloaded file data, the computer 4 first generates the hash key data of the related file data by using the hash function.

Then, the computer 4 transmits a request for payment of charge including the user ID of the content user 14, the generated hash key data, and the charge amount data to the computer 5.

[Computer 5]

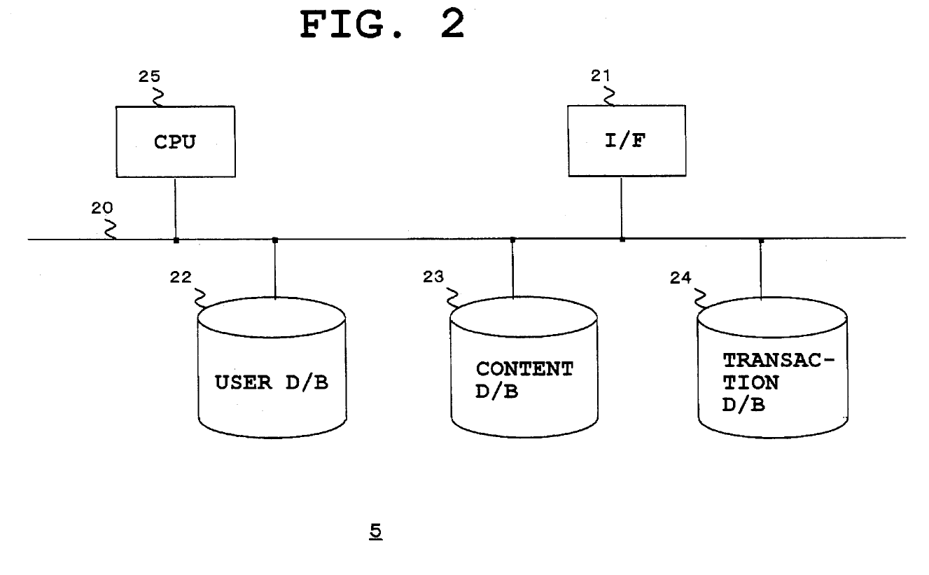

FIG. 2 is a functional block diagram of the computer 5 shown in FIG. 1.

As shown in FIG. 2, the computer 5 has, for example an interface (I/F) 21, a user database (D/B) 22, a content database 23, a transaction database 24 and a CPU 25. These are connected via an internal bus 20.

Here, the I/F 21 corresponds to the interface of the. present invention; the user database 22, content database 23, and the transaction database 24 correspond to the storage means of the present invention; and the CPU 25 corresponds to the controlling means of the present invention.

The interface 21 is connected to the network 2 shown in FIG. 1.

The user database 22 stores the user personal data of the content provider 13 and the content user 14 in a searchable format.

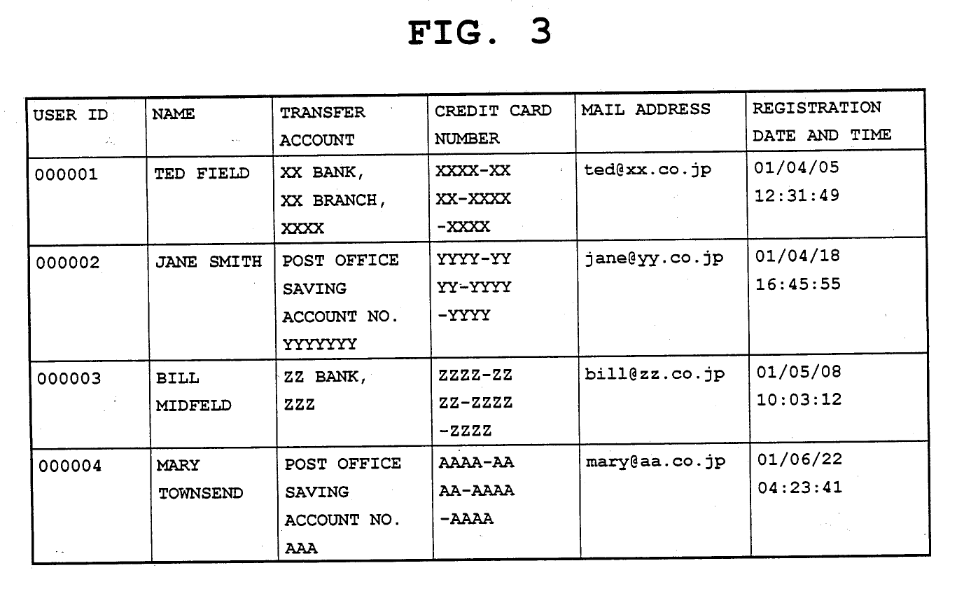

FIG. 3 is a view for explaining the user personal data stored in the user database 22.

As shown in FIG. 3, the user personal data indicates, for each user, for example the user ID, name, transfer account, credit card number, mail address, registration date, and so on linked together.

The “user ID” is an identifier such as numbers, symbols, etc. assigned so as to be able to identify an individual user such as the provider and user of the content.

The “name” is the name of the related user.

The “transfer account” is the account for the transfer of the related user necessary for the transfer of money by the related user via the mediator 15 or information in place of this.

The “credit card number” is the credit card number of the related user for the mediator 15 to debit or information in place of this.

The “mail address” is an electronic mail address of the related user.

The “registration date” is the date of registration of the related user in the mediator 15.

The content database 23 stores the content management data for managing the file data of the content registered by the content provider 13 in the mediator 15 in a searchable format.

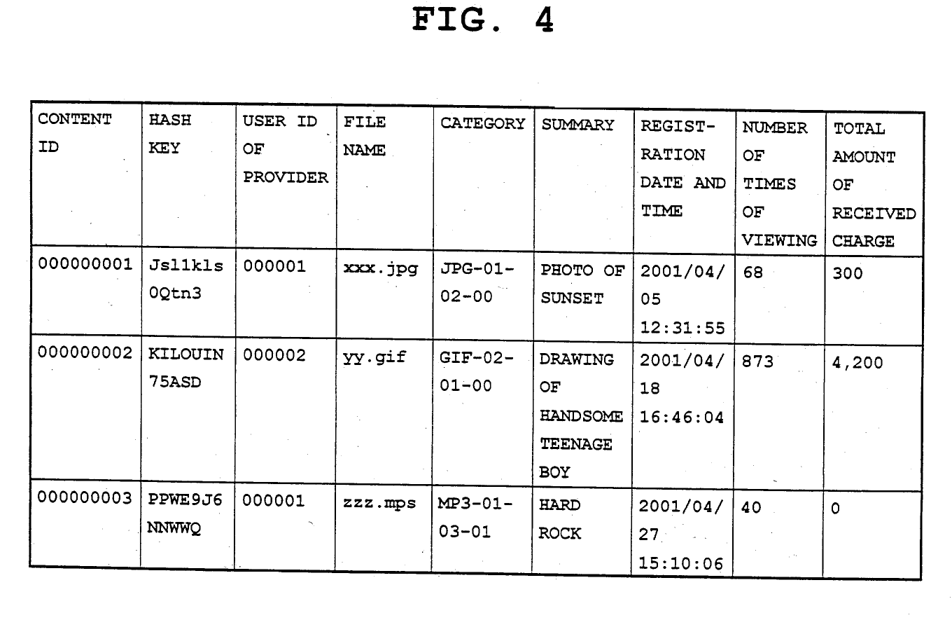

FIG. 4 is a view for explaining the content management data stored in the content database 23 shown in FIG. 2.

As shown in FIG. 4, the content management data indicates the content ID, hash key data, user ID of the provider, file name, classification, summary, registration date, number of times of viewing, and total amount of the received charge for the file data of each content registered in the mediator 15 by the content provider 13.

The “content ID” is an identifier such as numbers and symbols assigned so as to be able to identify the content data of the related file data.

The “hash key data” is data generated from the related file data by using the predetermined hash function. The hash key data becomes different even by slightly altering the file data and has the nature that it is usually very difficult to prepare other file data having the same hash key data as the hash key data generated from certain file data.

The “user ID of the provider” is the user ID of the content provider 13 providing the related file data.

The “file name” is the name of the related file data.

The “classification” is an identifier such as the field to which the related content data belongs or numbers and symbols expressing the classification.

The “summary” is a short text describing in brief the related content data, a simple explanation, etc.

The “registration date” is the date when the related file data was registered.

The transaction database 24 stores the transaction management data for managing a transaction performed by using the computer 5 in a searchable format.

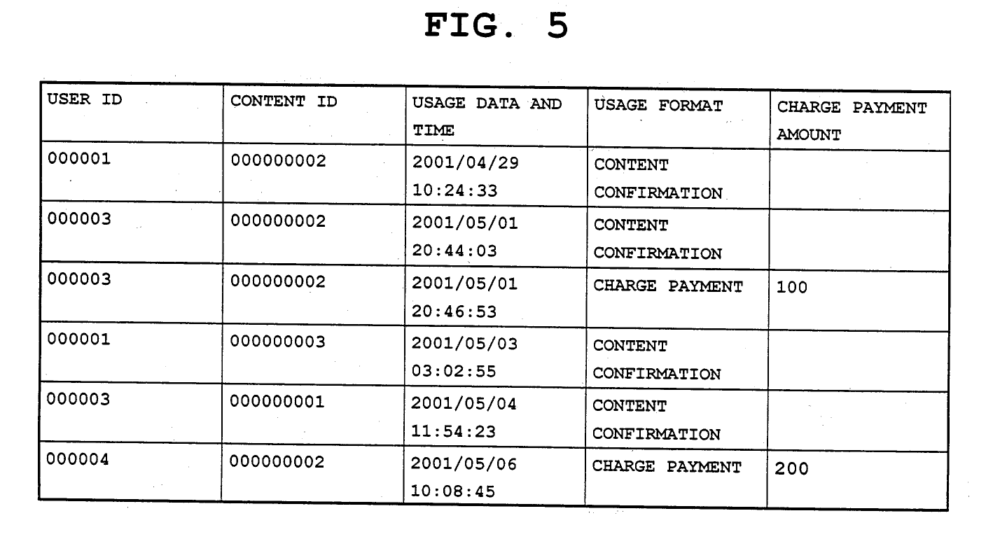

FIG. 5 is a view for explaining the transaction management data stored in the transaction database 24.

As shown in FIG. 5, the content usage situation management data indicates the user ID, content ID, usage date, usage format, and charge payment amount linked for every transaction.

The “user ID” is the user ID of the content user 14 performing the related transaction.

Further, the “content ID” is data for identifying the content data covered by the related transaction.

The “usage date” indicates the date when the usage concerning the related content was performed by the related transaction.

The “usage format” indicates the format of the usage of the file data by the related transaction. The “usage format” includes, for example, confirmation of content of the content data and payment of the charge.

The “charge payment amount” indicates the amount of the charge paid from the content user 14 to the content provider 13 for the download when the file data was downloaded to the content user 14 by the related transaction.

The CPU 25 operates based on a predetermined program (program of the present invention) and comprehensively manages the operation of the computer 5. The processing of the CPU 25 will be explained in detail in relation to the example of the operation mentioned later.

The computer 5 is connected to the network 2 and registers the personal data of the provider received from the computer 3 and the personal data of the user received from the computer 4 and holds the same as the user management data shown in FIG. 3.

Further, the computer 5 verifies the legitimacy (for example, that a virus is not included) of the file data received from the computer 3 and confirms the identity of the provider, then registers the related hash key data as the content management data for indicating the content ID, the user ID of the content provider 13, and the file name in FIG. 4 linked together.

Further, the computer 5 analyzes the content of the file data received from the computer 3 and automatically classifies the same and, at the same time, prepares summary data thereof and registers them as the content management data shown in FIG. 4.

Further, as shown in FIG. 4, the content management data shows, for each content, the number of times of viewing of the related content and the total value of the charge paid from the content user 14 for the usage of the file data of the related content (total amount of the received charge) linked together.

Further, the computer 5 searches for, for example, the content data having content matching with the an information provision request from the computer 4 of the content user 14 based on the classification and summary of the content management data in response to the related information provision request and transmits the search result to the computer 4.

Further, the computer 5 generates the transaction management data shown in FIG. 5 based on the transaction received from the content user 14 for the registered content and registers this in the transaction database 24.

Further, the computer 5 updates and deletes the data of the user database 22, the content database 23, and the transaction database 24 in response to a request or the like from the transaction, the computer 3, and the computer 4.

Below, an explanation will be given of examples of operation of the communication system 1 shown in FIG. 1.

### FIRST EXAMPLE OF OPERATION

In this example of operation, an explanation will be given of an example of operation of the case where the content provider 13 registers himself or herself in the computer 5.

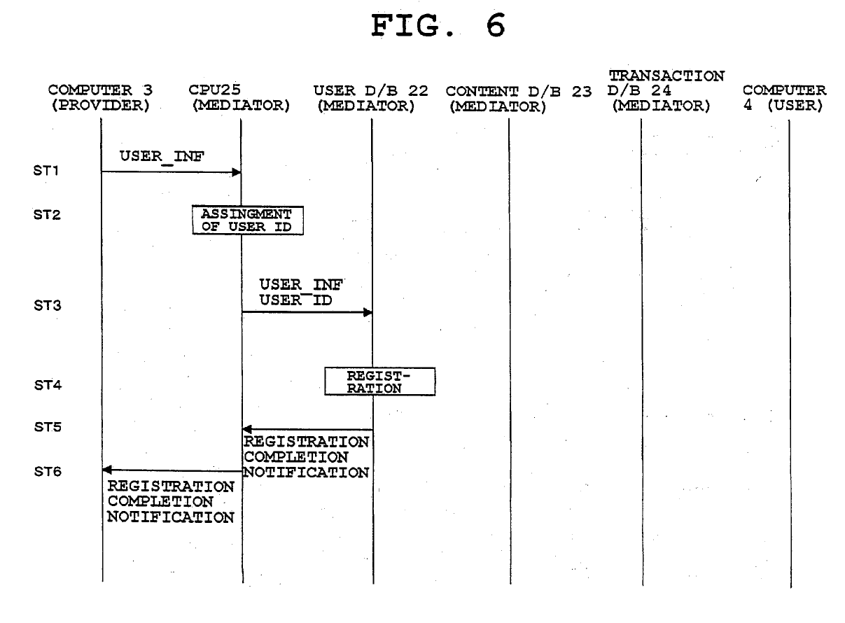

FIG. 6 is a flowchart for explaining the related example of operation.

Step ST1:

In response to the operation of the computer 3 by the content provider 13, the computer 3 transmits a user registration request including personal data USER_INF such as the name of the computer 3, transfer account, credit card number, and mail address to the computer 5.

The related user registration request is received at the interface 21 of the computer 5 shown in FIG. 4.

Step ST2:

The CPU 25 of the computer 5 shown in FIG. 4 assigns a user ID to the related user in response to the user registration request received at step ST1.

Steps ST3 and ST4:

The CPU 25 registers the personal data USER_INF input at step ST1 and the user ID assigned at step ST2 in the user database 22 as the user management data shown in FIG. 3.

Step ST5:

The user database 22 outputs a registration completion notification to the CPU 25.

Step ST6:

The CPU 25 transmits the registration completion notification to the computer 3 via the interface 21.

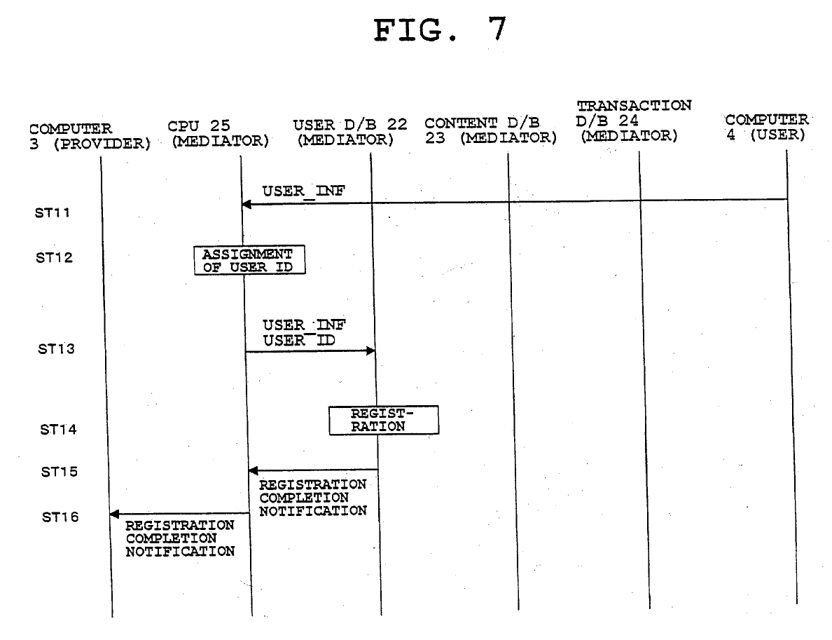

Further, an example of operation of the case where the content user 14 registers himself or herself in the computer 5 is shown in FIG. 7 and is basically the same as the case shown in FIG. 6 except for the point that the content user 14 performs the registration by using the computer 4.

### SECOND EXAMPLE OF OPERATION

In the related example of operation, an explanation will be given of the case where the content provider 13 registers the content data in the computer 5.

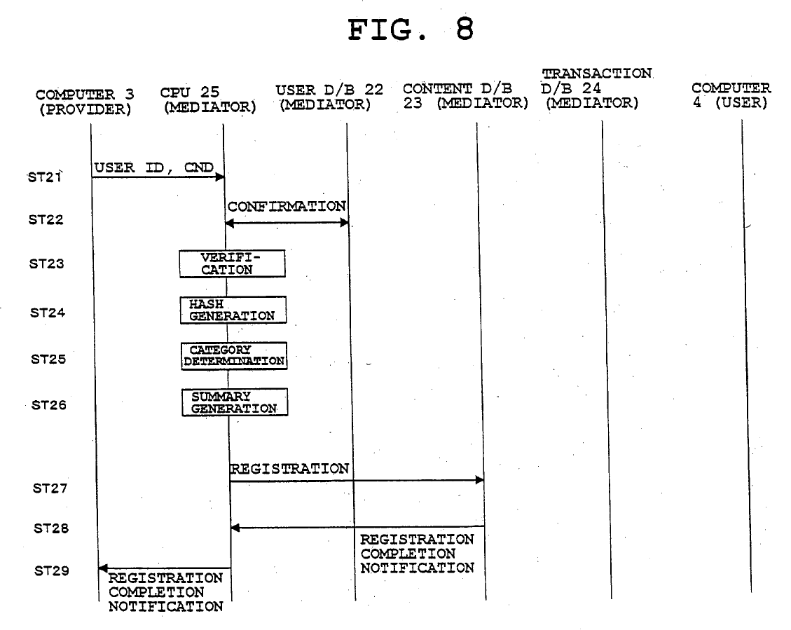

FIG. 8 is a flowchart for explaining the related example of operation.

Step ST21:

The content provider 13 operates the computer 3 to transmit a content registration request including the file data CND storing the user ID and the content data to the computer 5.

At this time, the file name is accompanied by the file data CND.

Further, the content provider 13 may transmit a content registration request including the name and transfer account to the computer 5 in place of the user ID.

Further, the computer 3 may also generate the hash key data of the file data CND by using a predetermined hash function and transmit the related hash key data together with the file data CND to the computer 5.

For example, in a case where Jane Smith registers an image of a drawing of a handsome teenage boy as new content, at least “Jane Smith” as the name, “Post Office Savings Account No. YYYYYYY” as the transfer account, and a file data “ppp.gif” holding the image are transmitted.

Further, Jane Smith has already been registered in the user database 22. Therefore, it is also possible not to transmit the name and the transfer account, but transmit “000002” as the user ID thereof. Further, it is also possible to generate the hash key data “KILOUIN75ASD” from “yy.gif” and transmit this together from the computer 3 to the computer 5.

Step ST22:

The CPU 25 shown in FIG. 4 searches through the user database 22 using the user ID received at step ST21 as the key and confirmsa whether or not the related user ID has been already registered.

Then, where the CPU 25 judges that the related user ID has been already registered, the processing routine proceeds to step ST23. In other cases, user registration is carried out according to the routine explained by using FIG. 6.

Further, when the content registration request including the name, transfer account, etc. of the content provider 13 is received at step ST21 in place of the user ID, the corresponding user ID is searched for from the user database 22 based on the related name, transfer account, etc. Where it is not found, user registration is carried out according to the routine explained by using FIG. 6.

Step ST23:

The CPU 25 verifies for example that a computer virus or socially unsuitable content is not included in the file data received at step ST21.

When the result of the verification is that a computer virus and socially unsuitable content are not included in the file data, the CPU 25 proceeds to the processing of step ST24.

On the other hand, when the result of the verification is that a computer virus or socially unsuitable content is included in the file data, the CPU 25 rejects the content registration and notifies this to the computer 3 of the content provider 13.

Step ST24:

The CPU 25 generates the hash key data of the file data received at step ST21 by using the hash function.

Note that, when the hash key data is included in the content registration request, the related hash key data and the generated hash key data are compared, and the legitimacy of the file data transmitted by the content provider is confirmed. If it is clarified that the file data is not legitimate, the following processing of the content registration is suspended, and suitable exceptional processing for requesting the re-transmission of the file data and the hash key data to the computer 3 or the like is performed.

Note that the hash key data can be generated at any timing after step ST21 up to step ST27.

The CPU 25 generates for example the hash key data “KILOUIN75ASD” from the file data of the content ID “000000002” shown in FIG. 5.

Step ST25:

The CPU 25 determines the classification based on the attribute of the content data stored in the related file data.

For example, the CPU 25 determines the category such as “GIF file”, “still image”, or “person”.

Note that, it is also possible for the content provider 13 to determine the related category and transmit the content registration request including the related category from the computer 3 to the computer 5.

The related category is used in for example a case where content information matching the content user 14 is provided to the computer 4 in response to a search request from the computer 4.

Step ST26:

The CPU 25 generates summary data matching the content of the content data stored in the related file data. The CPU 25 generates for example summary data such as “drawing of handsome teenage boy” as the summary of the content.

Note that it is also possible if the content provider 13 generates the related summary data and transmits the content registration request including the related summary data from the computer 3 to the computer 5.

The related summary data is used in for example a case where a summary of the content information matching the content user 14 is provided to the computer 4 in response to a search request from the computer 4.

Step ST27:

The CPU 25 registers the user ID received at step ST21 and the hash key data, category, summary, and registration date generated at steps ST24, ST25, and ST26 in the content database 23 as the content registration data shown in FIG. 4.

For example, “000000002” is assigned as the content ID, and the hash key data “KILOUIN75ASD” generated from the file data, provider ID “000002”, file name “yy.gif”, category “GIF-02-01-00”, and the summary “drawing of handsome teenage boy” generated from the file data are registered as the content management data in the content database 23.

Step ST28:

The content database 23 outputs the registration completion notification to the CPU 25.

Step ST29:

The content database 23 transmits the registration completion notification via the interface 21 to the computer 3.

Thereafter, the content provider 13 opens to the public the related file data on the computer 3 and transmits the related file data to for example the computer 4 by the peer-to-peer system.

### THIRD EXAMPLE OF OPERATION

In the related example of operation, an explanation will be given of a case where the computer 4 downloads the file data from the computer 3 by the peer-to-peer system and inquires about the legitimacy of the related file data to the computer 5.

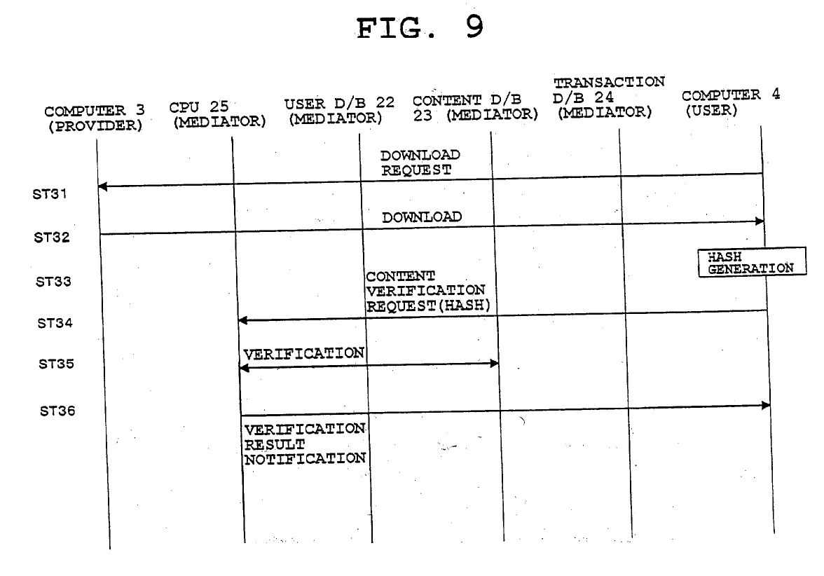

FIG. 9 is a flowchart for explaining the related example of operation.

Step ST31:

The computer 4 transmits a download request designating the file data to the computer 3.

Step ST32:

The computer 3 downloads (transmits) the file data to the computer 4 by the peer-to-peer system in response to the download request received at step ST31.

At this stage, the content user 14 cannot determine whether the file data downloaded to the computer 4 is one by a legitimate provider or it includes a computer virus.

Step ST33:

The computer 4 generates the hash key data of the file data downloaded at step ST32 by using the hash function.

Step ST34:

The computer 4 transmits the content verification request including the hash key data generated at step ST33 to the computer 5.

The related content verification request is received at the interface 21 of the computer 5 shown in FIG. 2.

Step ST35:

The CPU 25 of the computer 5 shown in FIG. 2 verifies whether or not the file data corresponding to the hash key data included in the content verification request received at step ST34 exists, that is, the legitimacy of the file data downloaded by the computer 4, by referring to the content database 23.

Step ST36:

The CPU 25 transmits the result of the verification to the computer 4 via the interface 21.

At this time, it is also possible if the CPU 25 reads out the information concerning the attributes of the related file data and the information concerning the content provider 13 from the content database 23 and transmits the information together with the result of the verification to the computer 4.

### FOURTH EXAMPLE OF OPERATION

In this example of operation, an explanation will be given of the case where the content user 14 receiving the download of the file data from the content provider 13 pays a charge to the content provider 13.

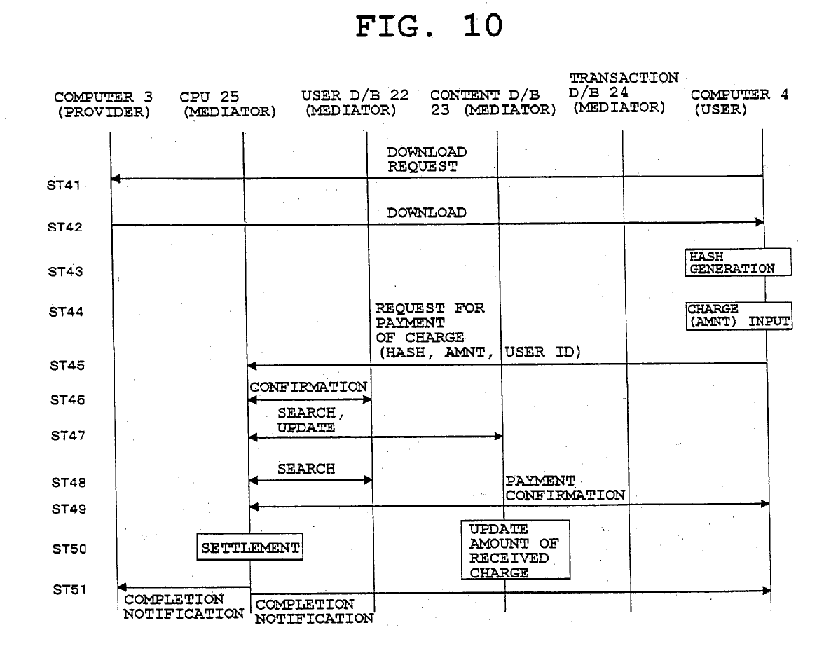

FIG. 10 is a flowchart for explaining this example of operation.

Step ST41:

The computer 4 transmits the download request designating the file data to the computer 3.

Step ST42:

The computer 3 downloads (transmits) the file data to the computer 4 by the peer-to-peer system in response to the download request received at step ST41.

Step ST43:

The computer 4 generates the hash key data of the file data downloaded at step ST42 by using the hash function.

Step ST44:

The content user 14 inputs the amount AMNT of the charge (contribution) to be paid to the content provider 13 to the computer 4.

Step ST45:

The computer 4 transmits the request for payment of charge including the hash key data generated at step ST43, the charge amount data AMNT indicating the amount of the charge input at step ST44, and the user ID of the content user 14 to the computer 5.

The request for payment of charge is received at the I/F 21 of the computer 5 shown in FIG. 2.

Note that, it is also possible to include the name and credit card number of the content user 14 in the request for payment of charge in place of the user ID.

Further, preferably the mail address of the content user 14 is included in the request for payment of charge.

Further, it is also possible if selection data of whether or not the charge is to be anonymously paid is included.

For example, where John Brown wishes to contribute 300 yen for usage of the file “xxx.jpg”, the request for payment of charge including at least “John Brown” as the name, the credit card number “ZZZZ-ZZZZ-ZZZZ-ZZZZ”, the hash key data “Js11k1s0Qtn3” generated from xxx.jpg, and the “300 yen” to be contributed is transmitted from the computer 4 to the computer 5.

Note that, “John Brown” has been already registered in the service user database, therefore, the name and the credit card number are not transmitted, but the request for payment of charge including the user ID “000003” is transmitted from the computer 4 to the computer 5.

Step ST46:

The CPU 25 of the computer 5 shown in FIG. 2 searches through for example the user database 22 by using the user ID of the content user 14 included in the request for payment of charge as a key in response to the request for payment of charge received at step ST45 and confirms if the content user 14 has been already registered.

Then, when the content user 14 has been already registered, the CPU 25 obtains the credit card number of the content user 14 from the user database 22.

Further, the CPU 25 acquires personal data such as the mail address of the content user 14 from the user database 22 when anonymous charge payment is not designated.

Note that, when the content user 14 is not registered in the user database 22, the CPU 25 performs the registration processing according to the routine shown in FIG. 6.

Further, where personal data updated or added for the content user 14 is included in the request for payment of charge, the database 22 is added to or updated by using the related personal data.

Step ST47:

The CPU 25 verifies if the file data concerned is registered by searching through the content database 23 based on the hash key data included in the request for payment of charge.

Further, the CPU 25 acquires the user ID of the content provider 13 of the related file data and, if necessary, the file name, from the content database 23.

The CPU 25 acquires for example the user ID “000001” of the provider and file name “xxx.jpg” from the hash key data “Js11k1s0Qtn3” by the content ID “000000001”.

When judging that the file data concerned is not registered in the content database 23, the CPU 25 notifies this to the computer 4 and suspends the following processing.

Step ST48:

The CPU 25 searches through the user database 22 by using the user ID of the content provider 13 acquired at step ST47 as a key and acquires the name and the transfer account of the content provider 13 as the search result.

The CPU 25 acquires for example the name “Ted Field” and transfer account “XX bank, XX branch, XXXX” from the user database 22 by using the user ID “000001” as a key.

Step ST49:

The CPU 25 makes the computer 4 display a payment confirmation screen including information useful for the final decision of the charge payment, for example, the fact that charge payment mediation is possible, the name of the content provider 13, and the charge amount.

Then, when receiving as input an instruction for payment from the computer 4, the CPU 25 proceeds to the processing of at step ST49, while suspends the processing in other cases.

By this, erroneous procedures by the content user 14 can be avoided.

Step ST50:

The CPU 25 performs settlement processing of the amount indicated by the charge data included in the request for payment of charge based on the credit card number of the content user 14 acquired at step ST46 and the transfer account of the content provider 13 acquired at step ST47.

For example, the CPU 25 performs the settlement processing such as debiting 300 yen from the credit card “ZZZZ-ZZZZ-ZZZZ-ZZZZ” of Bill Midfeld as the content user 14 and transferring 300 yen to the transfer account “XX bank, XX branch XXXXXX” of Ted Field.

When some sort of problem arises in the settlement processing, the CPU 25 performs exceptional processing, for example, the cancellation of hte debiting and transfer of the charge, and notifies this to the computer 4.

Step ST51:

The CPU 25 transmits the notification indicating the completion of the charge payment mediation to the computer 3 and the computer 4.

In the notification, for example, where Bill Midfeld wishes to anonymously pay the charge to Ted Field, the information of name etc. of Bill Midfeld is not notified to the computer 3, but notified as for example “a contribution of 300 yen was made for xxx.jpg”. To the computer 4, for example, is notified that “a contribution of 300 yen was made for xxx.jpg provided by Ted Field”.

This notification need not be performed.

As explained above, according to the communication system 1, even in the case where the field data is transmitted and received by the peer-to-peer system between the computer 3 and the computer 4, it becomes possible to pay the charge by the contribution or the like from the content user 14 to the content provider 13. Due to this, the useful content is opened to the public on the network 2 and usage can be promoted.

Further, according to the communication system 1, the content user 14 can receive information concerning the legitimacy of the received file data from the computer 5 and can safely use the received file data.

The present invention is not limited to the above embodiments.

For example, it is also possible if communication with the computers 3, 4, and 5 is realized by using email, functions on a Web browser, etc.

Further, the request and the transmission and reception of the data among the computers 3, 4, and 5 can be carried out after encryption.

Further, in the example shown in FIG. 1, the case of using one computer 3 and computer 4 each was exemplified, but a plurality of the computers 3 and computers 4 may also be used.

Further, in the above embodiments, there are also cases where the content provider 13 becomes the content user 14 and cases where the content user 14 becomes the content provider 13.

In this case, each of the computer 3 and computer 4 has functions of both of the computer 3 and the computer 4 mentioned above.

Further, it is also possible if at least two of the computers 3, 4, and 5 shown in FIG. 1 are realized on the same computer.

Further, in the example shown in FIG. 1 and FIG. 2, the case where the user database 22, content database 23, and transaction database 24 shown in FIG. 2 were placed in the computer 5 was exemplified, but it is also possible if at least one of them is placed in an apparatus different from the computer 5 or in another computer on the network 2.

Further, it is also possible if at least one of the user database 22, content database 23, and transaction database 24 shown in FIG. 2 is configured as the same database.

Further, it is also possible if the content database 23 is configured as a plurality of databases different from each other for every category of the content.

Further, it is also possible if the file data transmitted by the computer 3 is stored in the computer 5.

As explained above, according to the present invention, a communication method, computer, and program enabling suitable payment of a charge to a content data provider even when the content data is provided by the peer-to-peer system can be provided.

While the invention has been described with reference to specific embodiments chosen for purpose of illustration, it should be apparent that numerous modifications could be made thereto by those skilled in the art without departing from the basic concept and scope of the invention.

What is claimed is:

1. A communication method of a third computer for communicating with a first computer of a content provider and a second computer of a content user when said first computer transmits content data to said second computer, comprising the steps of:
communicating by said third computer with said first computer and said second computer to register personal management data concerning said content provider and said content user, and content management data concerning said content data,
receiving by said third computer from said second computer, a request for payment of a charge to said content provider for reception of said content data, and
performing by said third computer a task for payment of the charge to said content provider, based on the registered personal management data and said content management data in response to said request for payment.

2. A communication method as set forth in claim 1, further comprising the step of managing by said third computer the total amount of the charge paid with respect to each content data by using said content management data.

3. A communication method as set forth in claim 1, further comprising the steps of:
registering by said third computer further verification data indicating the legitimacy of the content data provided by said content provider,
receiving by said third computer a request inquiring about the legitimacy of said content data from said second computer, and
verifying by said third computer the legitimacy of said content data by using said verification data in response to said inquiry request and transmit the result of the related verification to said second computer.

4. A communication method as set forth in claim 3, further comprising the steps of:
registering by said third computer hash key data of said content data generated based on a predetermined hash function as said verification data,
receiving by said third computer said inquiry request including the hash key data of said content data from said second computer, and
comparing by said third computer said registered hash key data with the hash key data included in said inquiry request and verify the legitimacy of said content data.

5. A communication method as set forth in claim 4, further comprising the steps of:
receiving by said third computer said content data from said first computer and
generating and registering by said third computer said hash key data of said received content data based on said hash function.

6. A communication method as set forth in claim 4, further comprising the step of receiving by said third computer said hash key data of said content data generated by said first computer based on said hash function from said first computer and register the same.

7. A communication method as set forth in claim 1, further comprising the step of communicating by said third computer with said first computer and second computer through a network.

8. A computer for communicating with a first computer used by a content provider and a second computer, used by a content user, to receive content data from said first computer, comprising:
a storage means for storing personal management data for managing said content provider and said content user, and content management data for managing said content data;
an interface for receiving from said second computer a request for payment of a charge to said content provider for reception of said content data; and
a controlling means for performing a task for payment of the charge to said content provider, based on said personal management data and said content management data in response to said request for payment.

9. A computer as set forth in claim 8, wherein said controlling means manages the total amount of the charge paid for each content data using said content management data.

10. A computer as set forth in claim 8, wherein
said controlling means registers verification data indicating the legitimacy of the content data provided by said content provider and stores it in said storage means,
said interface receives a request inquiring about the legitimacy of said content data from said second computer, and
said controlling means verifies the legitimacy of said content data by using said verification data in response to said inquiry request and transmits the result of the related verification to said second computer.

11. A computer as set forth in claim 10, wherein
said controlling means registers hash key data of said content data generated based on a predetermined hash function as said verification data and stores it in said storage means,
said interface receives said inquiry request including the hash key data of said content data from said second computer, and
said controlling means compares said registered hash key data with the hash key data included in said inquiry request and verifies the legitimacy of said content data.

12. A computer as set forth in claim 11, wherein
said interface receives said content data from said first computer and
said controlling means generates and registers said hash key data of said received content data based on said hash function and stores it in said storage means.

13. A computer as set forth in claim 11, wherein:
said interface receives said hash key data of said content data generated by said first computer based on said hash function from said first computer and
said controlling means registers said received hash key data and stores it in same storage means.

14. A program to be executed in a computer for communicating with a first computer used by a content provider and a second computer, used by a content user, to receive content data from said first computer, comprising:
a routine for registering personal management data for managing said content provider and said content user, and content management data for managing said content data;
a routine for receiving from said second computer a request for payment of a charge to said content provider for the reception of said content data; and
a routine for performing a task for payment of a charge to said content provider, based on said personal management data and said content management data in response to said request for payment.
